(19) United States
(12) Patent Application Publication
(10) Pub. No.: US 2008/0153075 A1
(43) Pub. Date: Jun. 26, 2008

(54) Video display of high contrast graphics for newborns and infants

(75) Inventor: Lynn C. LaFiandra, Bryn Mawr, PA (US)

Correspondence Address: MONTGOMERY, MCCRACKEN, WALKER & RHOADS, LLP, 123 SOUTH BROAD STREET, AVENUE OF THE ARTS, PHILADELPHIA, PA, 19109, US

(73) Assignee: Baby Senses, Inc.

(21) Appl. No.: 12/005,221

(22) Filed: Dec. 26, 2007

Related U.S. Application Data
(60) Provisional application No. 60/877,196, filed on Dec. 26, 2006.

(51) Int. Cl. G09B 19/00

(52) U.S. Cl. 434/236; 434/262; 434/247

(57) ABSTRACT

Provided is a method for visually stimulating newborns and infants in the age range of birth to 6 months, wherein a video visual display of a series of high contrast, black and white images, or high contrast colors, such as red is presented. The visual display can be partially synchronized or accompanied with music for an audiovisual presentation.

### RELATED APPLICATIONS

This application claims benefit of U.S. provisional patent application Ser. No. 60/877,196, filed on Dec. 26, 2006, which is herein incorporated by reference.

### FIELD OF THE INVENTION

This invention is directed to a visual stimulation method for visual stimulation of newborns and infants.

### BACKGROUND

A baby is born with limited vision that is still developing after birth. An infant does not visualize or “see” objects in the environment in the same way as a toddler or an adult. His or her initial visual world is made up of black, white and grey, and is quite blurred and unfocused.

An infant's experiences with his or her environment may actually benefit brain development. Sensory experiences such as hearing and seeing can facilitate stimulation of brain cells. At birth, nerve cells in an infant's brain are disorganized and not well connected. In the first years of an infant's life, the infant's brain builds synapses. The amount and type of stimulation a baby receives has a direct affect on how many synapses are formed. Repetitive, appropriate stimulation helps strengthen synaptic connections. As a child matures, his or her brain receives input from all five senses, thereby helping nerve cells to multiply and form a multitude of connections with other nerve cells. This is why visual stimulation is so crucial. For example, research has shown that if a baby is kept blindfolded, the visual center in the brain can fail to develop, detrimentally affecting development of vision. On the other hand, under continuous visual input, the retina thrives, the optic nerve grows, and the visual part of an infant's brain develops.

Research findings indicate that infants from 0-6 months are most attracted to, and presumably best see, black and white and red, high contras images. Although products designed after this research exist in still formats (mobiles, image cards, etc.) no such visual products exist in an audiovisual format (such as a dynamic video presentation).

Until the present invention there remained a need in the art for an effective method for visually stimulating specifically a newborn or infant without further assistance from an adult.

### SUMMARY

A method for visually stimulating newborns and infants is described below. High contrast, black and white images, or high contrast colors, such as red, are presented as part of a video display in a manner that is visible to a newborn or infant such that the display will stimulate sensory nerves and the nervous system of the newborn or infant. The visual display can be partially synchronized or accompanied with music for an audiovisual presentation. It is an intention of the present invention that the method presented herein provides visual stimulation and visual “exercise” to a newborn or infant child.

Additional advantages and features of the invention will be set forth in part in the description, embodiments and figures which follow, and in part will become apparent to those skilled in the art on examination of the following, or may be learned by practice of the invention.

### BRIEF DESCRIPTION OF THE DRAWINGS

The foregoing summary, as well as the following detailed description of the invention, will be better understood when read in conjunction with the appended drawings. It should be understood, however, that the invention is not limited to the precise arrangements shown.

FIGS. 1A and 1B show a sample portion of a high contrast image of a video display that is stimulating to newborns or infants.

FIGS. 2A and 2B show an additional sample portion of a high contrast image of a video display that is stimulating to newborns or infants.

FIG. 3 shows a sample portion of a high contrast image of a video display that is stimulating to newborns or infants depicting a happy face.

FIG. 4 shows a sample portion of a high contrast image of a video display that is stimulating to newborns or infants depicting a snowflake.

FIG. 5 shows a sample portion of a high contrast image of a video display that is stimulating to newborns or infants depicting a sun.

FIG. 6 shows a sample portion of a high contrast image of a video display that is stimulating to newborns or infants depicting a white sunburst against a black background.

FIG. 7 shows a video display system for displaying high contrast images to newborns or infants.

### DETAILED DESCRIPTION OF THE INVENTION

The visual stimulation method described herein advantageously enhances the brain development of a newborn or infant by stimulating the visual and auditory senses of such a newborn or infant. While the invention is intended for human infants, it is understood that certain applications could benefit infant animals, such as in research settings or artificial habitats, such as a zoo, laboratory or veterinary hospital. The present invention further provides visual entertainment for newborns in the early months at a time when they have a limited ability to engage with their environments or in other activities.

In accordance with the present invention, select visual images (“visuals” or “images”) are dynamically presented in conjunction with music (collectively forming an audiovisual presentation) on a playback device, such as a television, computer, a handheld device, a media player, or other suitable audiovisual presentation devices and viewing means of types known in the art or yet to be developed.

The select visuals or images of the invention correspond to research findings regarding infant and child preferences for high contrast colors, particularly black and white, and graphics that are large, simple, and as a result, “in focus” for newborns. Fine-grained images present a distorted picture to a newborn or infant, and thus are not seen for what they actually are. For example, a detailed checkerboard pattern will appear entirely grey to an infant if it is displayed in too much detail because the child's nervous system is still at a stage of early development. For this reason, the high contrast visuals or images of the present invention are advantageous because they are easily viewed by newborns or infants.

In one embodiment of the present invention, age appropriate images are considered ones that are distinct and simple so that they can be easily viewed by a newborn of infant. By the time an infant is six to eight months of age, vision is more fully developed. Examples of suitable visual images for use in the invention are shown in the Figures.

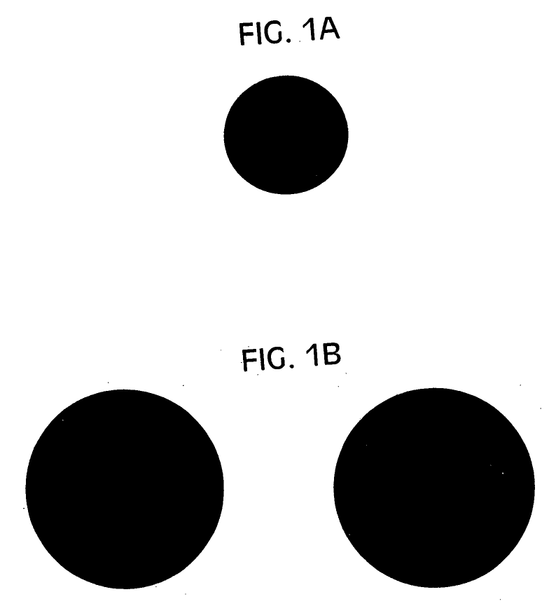

FIGS. 1A and 1B show representative images, such as filled circles. Filled circles can be displayed individually, such as shown in FIG. 1A, or in a group of two or more as shown in FIG. 1B. Images displayed on the screen may be stationery for brief periods of time, but continually changing, or can be displayed as alternating between more than one different image. In one embodiment of the invention, the image displayed or presented must be of a size in the range of that which an infant can see for purposes of visual stimulation, but not larger than an image that would occupy the entire area in which the visual image is displayed or presented. In one embodiment, to be visible to the newborn or infant, the high contrast image that is presented must be a minimum of one half inch in diameter or width, and not exceeding a diameter or width that would cause the high contrast image to be greater than the size of a screen on which the image is being viewed.

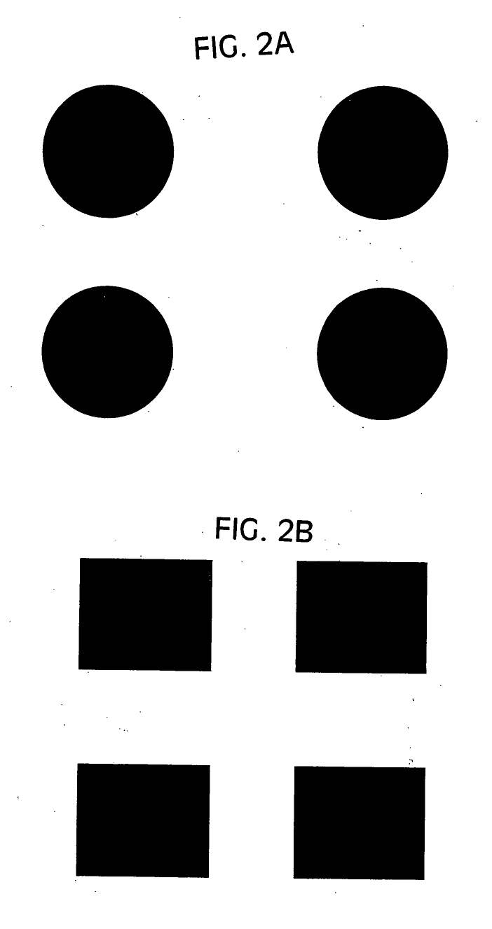

FIGS. 2A and 2B show additional high contrast images. For example, a group of images can be displayed, such as filled circles shown at FIG. 2A, for a brief or extended amount of time, and that image can alternate with another group of images, such as filled squares shown at FIG. 2B. Any number of images can be presented at a given time.

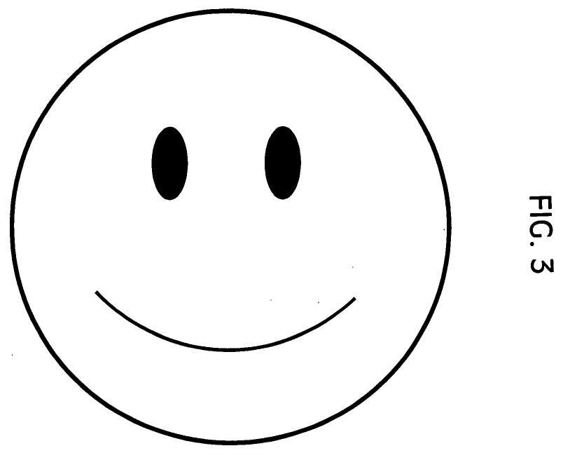

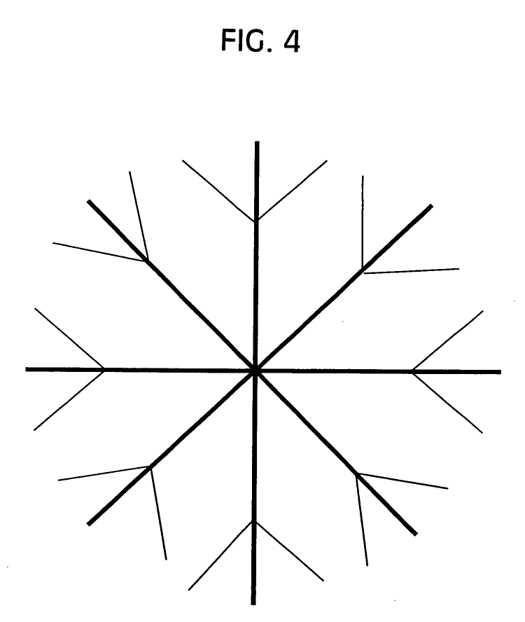

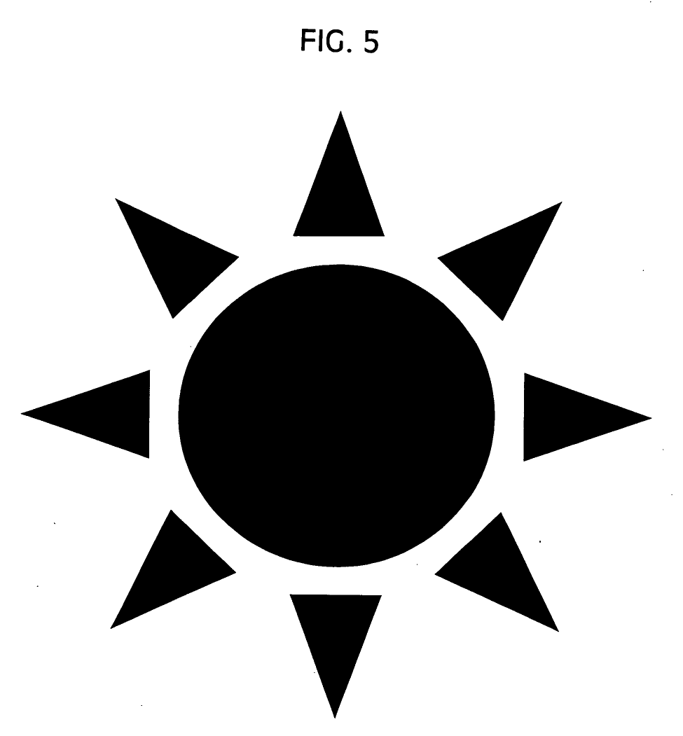

FIGS. 3, 4 and 5 show additional images suitable for the invention, such as a happy face (FIG. 3), a snowflake (FIG. 4) and a sun (FIG. 5). These additional images are representative only; many other images are suitable for visual display if depicted in simple, sufficiently large form and in high contrast, such as black and white, or black, white and red, or any combination thereof. In other words, other bold colors, such as royal blue or dark blue or the like may be used so long as the bold color meets the requirements of “high contrast”.

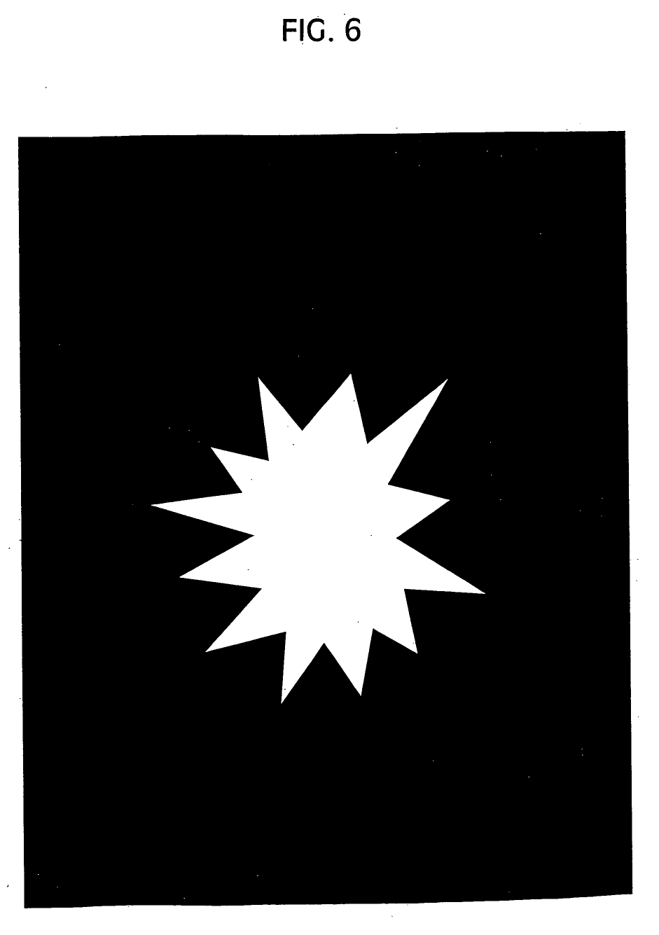

FIG. 6 shows an additional manner of presenting images in high contrast. For example, the white starburst is shown against a high-contrast black background or vice versa.

Display of images is meant to mean visible to the eye of an infant or newborn in an age range of birth to six months, and refers to the presentation of displayed images. It should be understood that each image may appear individually for any length of time, or an image can be shown together with other images for any length of time, so long as the display does change as compared to a stationery image. As one image is displayed, additional images can be added to the presentation, so that while the presentation may begin with a single image, it may end with multiple images on display. Thus, the display of high contrast images is also referred to as a “series” of images, in that a sequence or succession of images is presented for visual stimulation of a newborn or infant. For example, a circular image, such as shown in FIG. 1A may be initially displayed, with sequential circular images added to the display, thereby arriving at a series of two, then three, then four images, as shown at FIG. 2A, and so on. In the alternative, the number of the images is decreased from a plurality of images to one or any variation there between. In further embodiments, images can fade in or out of visibility and can enter the field of view from any angle or direction.

In another embodiment of the invention, high contrast images move about during the presentation or display at a rate of movement that allows a newborn or infant to “track” the image. Tracking refers to the ability to follow an object with the eye. In other words, images move about on the screen of a playback device in such a fashion as to promote tracking of eye movement in a newborn or infant. Tracking of visual objects by the newborn or infant viewer further aids the visual stimulation process, and is an important milestone in vision development, when eye muscle coordination is established. Videos currently available for toddlers do not present images at a rate that allows newborns or infants to track the images. Rather, images are usually fast moving, creating an experience for newborns or infants that is too complex, over stimulating and images that cannot be “seen”, and therefore do nothing to aid in visual stimulation.

For the purposes of this invention “high contrast” refers to the degree by which there is a sharp or extreme difference in darkness or color density between light and dark areas of the image. Images visible to the newborn or infant suitable for visual stimulation include images that are presented in high contrast, such as black and white, or black, white and red, or in a combination of high contrasting colors. In one embodiment, images can be displayed as images stationery for a brief period of time but continually changing. In yet another embodiment, images are synchronized in movement to music, such that images appear to move to the beat or rhythm of music accompanying the visual display. Music can be of any type or style of music suitable to enhance the audiovisual presentation such that the music is not over stimulating to the newborn or infant.

Images for visual stimulation refer to objects and visual images visible to a newborn or infant in an age range of birth to 6 months. Images also include shapes, objects, characters, and graphics and can be presented in any manner in an audiovisual presentation. Images are presented in an audiovisual format, but can be from any source including, photographs, drawings, sketches, paintings, text, computer graphics, or any other medium to which an image can be fixed for display.

In an embodiment of the present invention, the content of the audiovisual presentation may be stored on one or more audiovisual storage and computer-readable mediums, such as videotape, videodisc, CD technology, DVD technology, computer storage media, and other media formats. In another embodiment of the present invention, the audiovisual presentation is comprised of computer-readable media executed by a processor of a computer system. The content may be acquired from a remote source via wired, fiber optic, or wireless connection. For example, content of the audiovisual presentation may be downloaded from the Internet to provide high contrast images in accordance with the present invention. The content may also be acquired from a content service provider, such as a cable, satellite, or communications company. The content may also be accessed from one or more local storage mediums, such as flash memory, or disc.

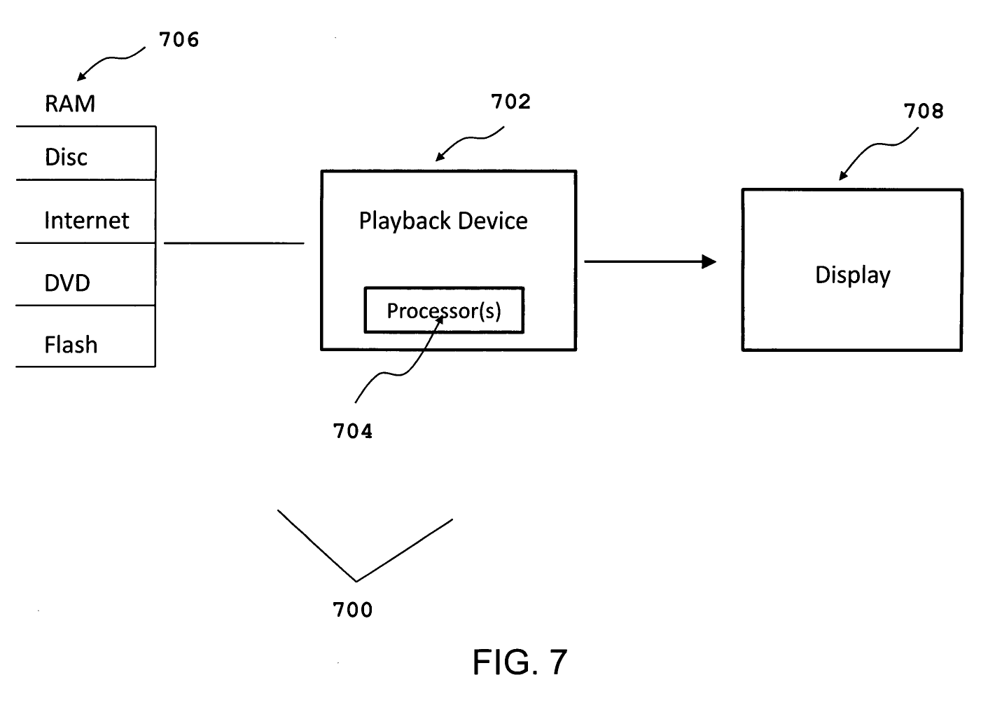

FIG. 7 is an overview diagram of an exemplary video display system 700 within which various functionalities described herein can be fully or partially implemented. A playback device 702 may include one or more processors 704 coupled to the playback device 702. Playback device 702 represents one or more of any variety of devices for viewing video-format media, such as a DVD player, VCR player, computer, television, or hand-held device.

Playback device 702 also includes access to memory, which represents a variety of computer readable media 706. Such media can be any available media that is accessible by processor(s) 702 and includes both volatile and non-volatile media, removable and non-removable media. For instance, memory may include computer readable media in the form of volatile memory, such as random access memory (RAM) and/or non-volatile memory in the form of read only memory (ROM). In terms of removable/non-removable storage media or memory media, memory may include a hard disk, a magnetic disk, a floppy disk, an optical disk drive, CD-ROM, flash memory, etc. The playback device 702 may also include links to other media content, such as an Internet website, disk drive, or other media known to one skilled in the art.

In one embodiment, a user can manipulate playback device 702 manually or via a remote control devices. The playback device 702 also includes a display 708 as part of the playback device 702 or connected to or integrated with the playback device 702. In one embodiment, display 708 is a screen of a playback device 702, such as a television. In another embodiment, display 708 is a computer monitor. Any suitable means for providing a video viewing screen or area for presentation (such as a projector screen) is a suitable display as it relates to the present invention.

The present invention also provides for media including communication media. Communication media typically embody computer-readable instructions, data structures, program modules, or other data in the modulated data signal, such as a carrier wave or other transport mechanism, and include any information delivery media. The term “modulated data signal” means a signal that has one or more of its characteristics set or changed in such a manner as to encode information in the signal. By way of example, and not limitation, communication media include wired media, such as a wired network or direct-wired connection, and wireless media, such as acoustic, RF, infrared, and other wireless media. Combinations of any of the above should also be included within the scope of computer-readable media.

Playback devices include any device capable of visual and/or audio-visual presentation, such as a VCR player, a DVD player, a television, a monitor, a computer, or handheld devices. While in most embodiments the visual display is presented on the screen of a playback device, it is not meant to be so limiting. For example, in another embodiment images could also be presented and displayed by a projector television, in which case the presentation is viewed by a newborn or infant on a screen comprising a wall or a projector screen.

In yet another embodiment, selected still and moving high contrast images in black and white or high contrast colors form the basis of a visual display in video format. Images, such as geometric shapes shown in the FIGS. 1-6, can be displayed on a screen of the playback device in various patterns or patterns of movement while accompanied by music. For visual impact, the shapes slowly move across the screen in synchronicity with music. For example, the image of a filled circle may appear on a viewing screen. The filled circle may bounce up and down, grow in size and then split into two circles. Filled circles could be followed by squares, and the pattern could repeat or a new pattern could be presented as long as each image complies with the high contrast requirements of the present invention. Movement may follow the melody or rhythm of music that accompanies the visual presentation.

A further embodiment of the present invention includes printed manuals, including instructions for the use of computer readable media and the visual stimulation of a newborn or infant. Instruction manuals can also include a description of images shown in the video and information regarding musical accompaniments, such as composer and movement, or singer and songwriter.

Although the above embodiments synchronize the visual content of the presentation with music, in certain embodiments, music can be eliminated entirely from the content of a display or presentation or during one or more portions of a display or presentation.

In one embodiment, the video or audiovisual presentation or display can be controlled by any external or internal control able to control the presentation, such as a remote control. Thus, an adult, caregiver, or parent is able to manipulate the sequence of images presented, or repeat images that are particularly engaging to the newborn or infant. In yet another embodiment, controlling the sequence of the images presented allows the adult, caregiver or parent to skip or pass over portions that may not be enjoyable to the newborn or infant. This embodiment is has particular significance when it may be necessary to help stimulate development in a newborn or infant that presents visual difficulties at birth, such as limited response to external visual stimuli. The visual stimulation method of the present invention could be particularly helpful for a newborn or infant where a concern for a “lazy eye” may be of concern.

Research has proven that black and white “contrasts” register notably more on a baby's retina and send the strongest visual signals to the child's brain. Promoting visual stimulation provides a foundation for the development of later fine and gross motor skills, as well as sensory motor development.

Exposing newborns or infants to an audiovisual presentation designed specifically for them, with colors and images that they can actually see, is like turning on the lights. In contrast, videos currently on the market cater to toddlers and use random colors and complex images that newborns cannot see or visualize clearly, and that to a newborn or infant appear grey and entirely out of focus. Moreover, videos marketed as learning systems require human intervention, such as a caregiver or parent to facilitate learning and stimulation.

While the foregoing specification has been described with regard to certain preferred embodiments, and many details have been set forth for the purpose of illustration, it will be apparent to those skilled in the art that the invention may be subject to various modifications and additional embodiments, and that certain of the details described herein can be varied considerably without departing from the spirit and scope of the invention. Such modifications, equivalent variations and additional embodiments are also intended to fall within the scope of the appended claims.

I claim:

1. A method for visually stimulating a newborn or infant, the method comprising:
generating at least one of a series of high contrast images visible to a newborn or infant;
moving the at least one of a series of high contrast images at a maximum allowable rate that corresponds to the rate at which the newborn or infant can visually track the high contrast images;
displaying the series of high contrast images for view by the newborn or infant on a playback device.

2. The method of claim 1, further comprising accompanying one or more of the series of high contrast images with music, collectively forming an audiovisual presentation.

3. The method of claim 1, wherein the series of high contrast images comprise images presented in black and white or high contrast colors or any combination thereof.

4. The method of claim 1, wherein the playback device comprises a computer, monitor, screen, television, handheld device, DVD player or VCR player.

5. The method of claim 1, wherein the newborn or infant is in an age range of birth to six months.

6. A computer-readable medium comprising computer executable instructions for carrying out the method of claim 1.

7. One or more computer-readable media, comprising computer-executable instructions that, when executed by one or more processors, causes the one or more processors of a computer system to: generate visually stimulating images to a newborn or infant, whereby the visually stimulating images comprises at least one of a series of a high contrast images visible to a newborn or infant; present the series of high contrast images moving at a maximum allowable rate that corresponds to the rate at which the infant can visually track the high contrast image; and display the series of high contrast images for view by the newborn or infant on a playback device.

8. The computer-readable media of claim 7, wherein the computer-readable media comprises a videotape, CD, DVD, portable storage media, Internet website or media from a content service provider.

9. The computer-readable media of claim 7, further comprising instructions for use thereof.

10. The computer-readable media according to claim 7, wherein the playback device comprises a computer, monitor, screen, television, handheld device, DVD player or VCR player.

11. The computer-readable media according to claim 7, wherein the series of high contrast images comprise images presented in black and white or high contrast colors or any combination thereof.
